(19) United States
(12) Patent Application Publication
(10) Pub. No.: US 2013/0226629 A1
(43) Pub. Date: Aug. 29, 2013

(54) SYSTEM FOR MANAGING AN ASSET

(71) Applicant: Russell Quinn, East Fremantle (AU)

(72) Inventor: Russell Quinn, East Fremantle (AU)

(73) Assignee: BOAT EQUITY PTY LTD, East Fremantle (AU)

(21) Appl. No.: 13/405,077

(22) Filed: Feb. 24, 2012

(51) Int. Cl. G06Q 10/02

(52) U.S. Cl. 705/5

(57) ABSTRACT

A system for managing an asset is having a plurality of defined parties authorized to use the asset is disclosed. The system comprises a communications interface arranged to facilitate network communications with the system from a remote location, and a data storage device arranged to store information indicative of bookings to use the asset by an authorized party to the asset. A corresponding method is also disclosed.

### Field of the Invention

The present invention relates to a system for managing an asset and, in particular, to a system for managing usage of an asset such as a jointly owned asset.

### BACKGROUND OF THE INVENTION

It is known for multiple parties to jointly purchase an asset, such as a boat or holiday house, and to jointly use the asset according to a planned arrangement between the parties. However, such an arrangement is difficult to manage effectively, in particular in relation to apportioning costs associated with the shared asset and managing usage times between the parties so that each party obtains a fair benefit from the asset. For these reasons, it is common for conflict to arise between the parties.

### SUMMARY OF THE INVENTION

In accordance with a first aspect of the present invention, there is provided a system for managing an asset having a plurality of defined parties authorized to use the asset, the system comprising:
a communications interface arranged to facilitate network communications with the system from a remote location; and
a data storage device arranged to store information indicative of bookings to use the asset by a party to the asset;
the system being arranged to receive a booking request from a party to the asset from a remote location and to store information indicative of received bookings in the data storage device; and
the system being arranged to regulate bookings to use the asset such that usage of the asset by each of the defined authorized parties is controlled.

In one embodiment, the system is arranged to regulate bookings by weighting days according to desirability.

In one embodiment, the system is arranged to allocate points to each day according to desirability whereby relatively more desirable days are allocated a relatively high number of points and relatively less desirable days are allocated a relatively low number of points. In one arrangement, weekends are allocated a relatively high number of points and weekdays are allocated a relatively low number of points. In one embodiment, public holidays are allocated the highest number of points, Saturdays and Sundays are allocated the next highest number of points, Fridays are allocated the next highest number of points, and weekdays are allocated the least number of points.

In one example, public holidays are allocated 70 points, Saturdays and Sundays are allocated 50 points, Fridays are allocated 30 points, and Mondays to Thursdays are allocated 20 points.

In one embodiment, the system is arranged to provide each of the defined authorized parties to the asset with a defined maximum number of standard points.

In one arrangement, each party is provided with a maximum standard points value each month.

In one embodiment, the system is arranged so as to add standard points to an accrued standard points value each time the party books to use the asset up to the maximum standard points value.

In an alternative embodiment, the system is arranged so as to deduct standard points from a maximum standard points value each time the party books to use the asset.

In one embodiment, the system is arranged to permit a party to the asset to book to use the asset using standard points up to 2 months in advance.

In one embodiment, the system is arranged to allow a party to purchase standard points beyond the maximum standard points allocation, the additional points having a defined monetary value. The monetary value assigned to the additional points may be dependent on a monetary value associated with the asset such that a relatively higher monetary value is assigned to the additional points for a relatively higher monetary value asset and a relatively lower monetary value is assigned to the additional points for a relatively lower monetary value asset.

In one embodiment, the system is arranged to provide each party to the asset with a defined number of wild card points usable to book the asset more than 2 months in advance, for example 12 months in advance.

In one embodiment, the number of standard points provided to each party to the asset is determined according to the proportional ownership of the asset by the party.

In one embodiment, the number of wild card points provided to each party to the asset is determined according to the proportional ownership of the asset by the party.

In one embodiment, the system is arranged to enable a party to challenge a booking made by another party according to defined rules. The rules may be such that a challenge is permitted up to 7 days after a booking is made. In one arrangement, the rules are such that if the booking relates to a public holiday priority for the booking is given to a party who has not booked the boat on the corresponding public holiday in the previous year and/or such that priority for a booking is given to a party having the lowest total number of used standard points at the time of the challenge.

In one embodiment, the system is arranged to facilitate entry into the system of asset information indicative of the asset and party information indicative of the defined authorized parties to the asset, and to store the asset information and the party information in the date storage device.

In one embodiment, the system is arranged to produce a legal agreement appropriate for circumstances wherein multiple parties are desiring to share usage of an asset, the system automatically populating at least some fields in the legal agreement using the asset information and/or the party information.

In one embodiment, the system is arranged to provide different login types, and to modify access to the system based on the login types. In one arrangement, multiple roles are assigned to multiple parties to the asset, and the system is arranged such that the login type for a party is dependent on the role assigned to the party. The roles may comprise an administrator role, an accounts management role, and a maintenance management role.

In one embodiment, the system is arranged to enable a party to enter information indicative of fuel usage after usage of the asset has occurred, and to record a monetary amount indicative of the fuel usage in the data storage device. The system may be arranged to receive and store information indicative of a fuel price per unit volume and/or information indicative of engine fuel usage per unit time, and the entered information indicative of fuel usage may comprise engine hours information or fuel meter information usable by the system to calculate a monetary amount for fuel usage based on the engine hours information or fuel meter information.

In one embodiment, the system is arranged to facilitate selection by a party of engine parameters associated with an asset and to derive an estimate of fuel usage per unit time based on the selected engine parameters.

In one embodiment, the system is arranged to facilitate entry by a party of report information indicative of service information, repair information, and so on.

In one embodiment, the system may be arranged to send a communication to a party based on defined criteria, such as when a booking is made by another party, when a report is entered by another party, and so on.

The communication may be made by email and/or SMS.

In one arrangement, the asset is jointly purchased by a plurality of parties, whereby ownership and usage of the asset by the parties is managed by the system.

In an alternative arrangement, the asset is owned by one or more but not all of a plurality of parties, whereby usage of the asset by the parties is managed by the system.

In one arrangement, the system is accessible using a computing device such as a personal computer, a PDA, an iPod®, an iPad®, and/or a mobile phone.

The system may be accessible through the Internet.

In one embodiment, the system comprises a web server arranged to serve web pages to a party through the Internet, the web pages being used by the party to communicate with the system including making bookings to use the asset.

In one arrangement, the asset is a boat, a house, a caravan, or an aircraft.

In accordance with a second aspect of the present invention, there is provided a method of managing an asset having a plurality of defined parties authorized to use the asset, the method comprising:
facilitating network communications with the system from a remote location;
receiving a booking request from a party to the asset from a remote location;
storing information indicative of received bookings in a data storage device; and
regulating bookings to use the asset such that usage of the asset by each defined authorized party is controlled.

In accordance with a third aspect of the present invention, there is provided a log book for recording data associated with usage of an asset of the type having a plurality of associated parties authorized to use the asset, the log book comprising;
a plurality of primary pages, each primary page including at least one field usable to record data associated with usage of an asset, and each primary page being separable from the log book;
a plurality of secondary pages, each secondary page being associated with a primary page and being a duplicate of the associated primary page and being arranged such that data recorded on the primary page is copied to the associated secondary page.

In one embodiment wherein the asset is a boat or an aircraft, the log book includes fields usable to record the name of a booking party, the date, the origin and destination of a journey, and either the engine hours or fuel meter readings for the journey.

### BRIEF DESCRIPTION OF THE DRAWINGS

The present invention will now be described, by way of example only, with reference to the accompanying drawings, in which:

FIG. 1 is a schematic block diagram of a system for managing an asset in accordance with an embodiment of the present invention with the system shown in relation to a plurality of client devices; and

FIGS. 2 to 15 are diagrammatic representations of screens produced by the system shown in FIG. 1 during use.

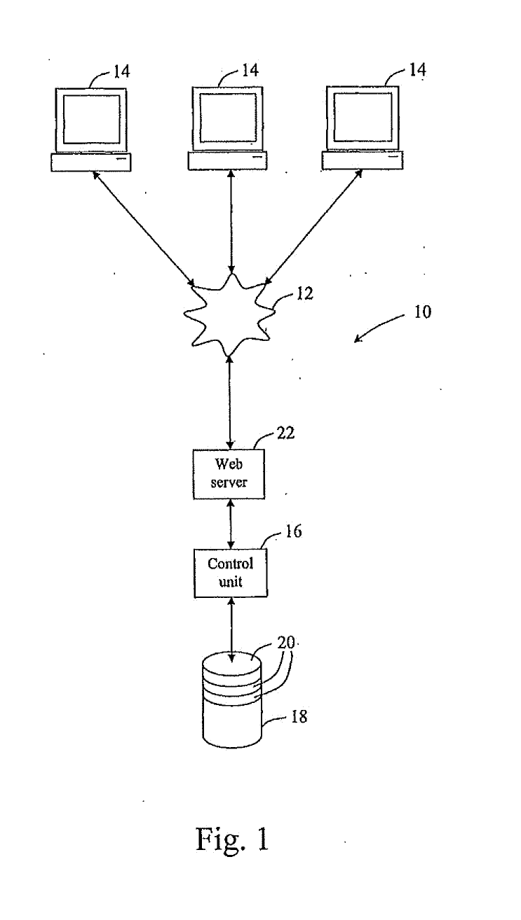

### DESCRIPTION OF AN EMBODIMENT OF THE INVENTION

Referring to the drawings, there is shown a system 10 for managing an asset which has been or is proposed to be purchased by several parties, or which has been or is proposed to be purchased by one party and wherein the usage of the asset is desired to be shared between several defined authorized parties.

In the present example, the asset is a boat which has been or is proposed to be purchased jointly by several parties. However, it will be understood that the system is equally applicable to management of other assets such as holiday homes, aircraft, caravans, or any asset wherein usage of the asset is desired to be shared between several parties. In the presently described embodiment, it is assumed that three parties have jointly purchased a boat and are desiring to manage the boat, in particular usage of the boat. However, it will be understood that other arrangements are envisaged.

The system 10 in this example is implemented online such that the system 10 is accessible from a remote location through a communications network such as the Internet 12 using any suitable communication enabled device. In this example, the system 10 is accessible using client devices in the form of personal computing devices 14, each of which is associated with a party to the asset managed by the system 10. However, it will be understood that any communications enabled device is envisaged, such as mobile phones, PDAs, and so on.

The system 10 comprises a control unit 16 arranged to control and coordinate operations in the system, in particular to coordinate storage and retrieval of information relating to one or more assets managed by the system 10 in a database 18. In this example, the database 18 is a relational database and is arranged such that each asset managed by the system 10 has an associated set of records 20 which may include one or more tables appropriately linked so as to efficiently store information necessary for managing the asset.

The system 10 in this example also includes a web server 22 arranged to retrieve information relating to an asset from the database 18, to serve the asset information as information embedded in web pages to requesting client devices 14, and to receive information from the client devices 14 for storage in the database 18.

In the present embodiment, the control unit 16, the database 18 and the web server 22 are implemented by a suitable computing device equipped with appropriate programs to carry out the respective functions of the control unit 16, the database 18 and the web server 22. For example, the database 18 may be an SQL type database with the computing device provided with appropriate database management software.

The system 10 is arranged to provide parties intending to share an asset with a structured arrangement for managing the asset, and in particular for managing usage of the asset. The system 10 facilitates sharing of usage of the asset by associating a points value with each possible usage day and allocating to each party a defined number of points. Each party may then use their allocated points to book desired usage days. In the present example, the number of points allocated to the parties are calculated according to the proportional ownership of the asset by the parties. For example, 600 standard points may be provided per month to be divided between the parties according to their proportional ownership. In the present embodiment, three parties exist and the proportional ownership is 33% each, so each party is provided with 200 points per month. Points which are not used at the end of each month expire and each party receives a new standard points allocation at the beginning of each month.

It will be understood that by setting the number of points available to a party and the daily points values at appropriate levels, it is possible to ensure that no single party is able to dominate usage of the asset and to thereby encourage fair usage by all parties. Fair usage can be further ensured by incorporating booking rules into the system.

In one arrangement, in order to prevent one party from dominating usage on the most popular days, different points values may be associated with different days according to the desirability of the day. For example, week days may be associated with 20 points, Fridays associated with 30 points, weekends associated with 50 points and public holidays associated with 70 points.

In the present embodiment, the system 10 also allocates wild card points to each party which may be used at any time over a longer advance period than the standard points, such as 1 year in advance. As with the standard points allocation, the number of points allocated to the parties are calculated according to the proportional ownership of the asset by the parties. For example, 840 wild card points may be provided per year to be divided between the parties according to their proportional ownership. In the present embodiment, three parties exist and the proportional ownership is 33% each, so each party is provided with 280 wild card points.

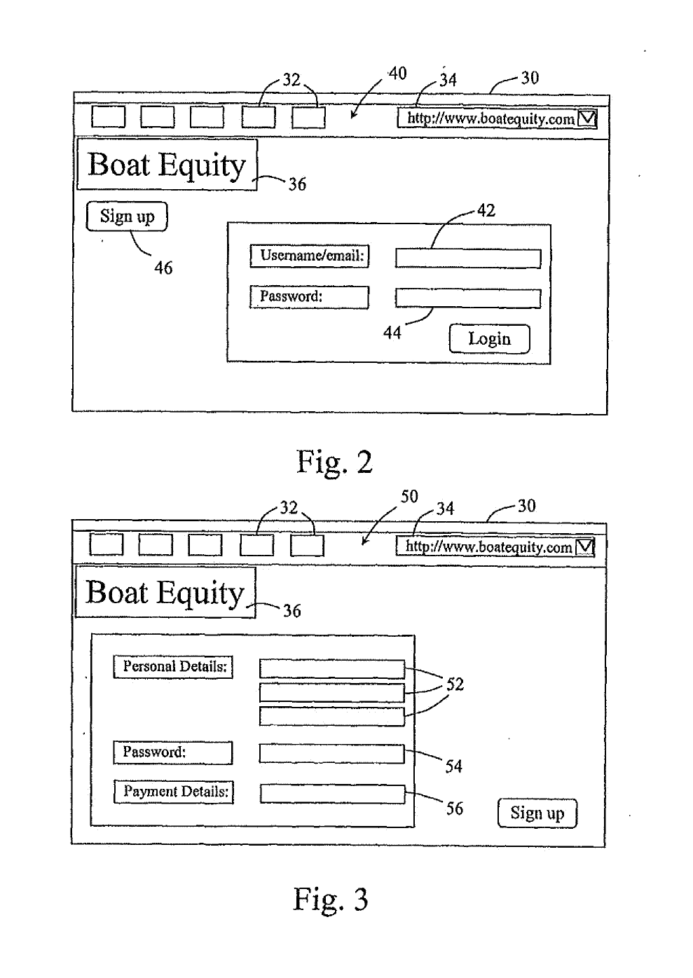

FIGS. 2 to 15 show representations of screens served to web clients 14 via the web server 22 during use. Like and similar features shown in the Figures are indicated with like reference numerals.

In the present example, a party accesses the system 10 through a web page on the Internet using a web browser 30 as shown in FIG. 2. The web browser 30 has conventional browser control buttons 32 usable to control browser functions such as web page navigation functions, and an address bar 34. A party is able to access a login screen 40 associated with the system 10 by entering an address associated with the system into the address bar 34. Using the login screen 40, a party is able to enter personal user name and password details in respective user name and password boxes 42, 44 in order to gain access to the system. Alternatively, if a party has not yet registered with the system 10, the party may commence a signup process by activating a signup button 46, for example using a mouse.

In the present example, the login screen 40 also includes advertising material and/or branding such as a company logo 36 associated with operators of the system 10.

When the signup button 46 is activated, a signup screen 50 as shown in FIG. 3 is displayed in the web browser 30. The signup screen 50 includes personal details boxes 52 usable to enter name and address details associated with the party, a new password box 54 usable to create a new password to be associated with the party on the system 10, and a payment details box 56 usable to enter payment details into the system 10 such as credit card details.

The entered payment details may be used to transfer payment to operators of the system 10 and/or to receive ongoing payments from the party, for example in relation to maintenance costs, fuel usage, and so on.

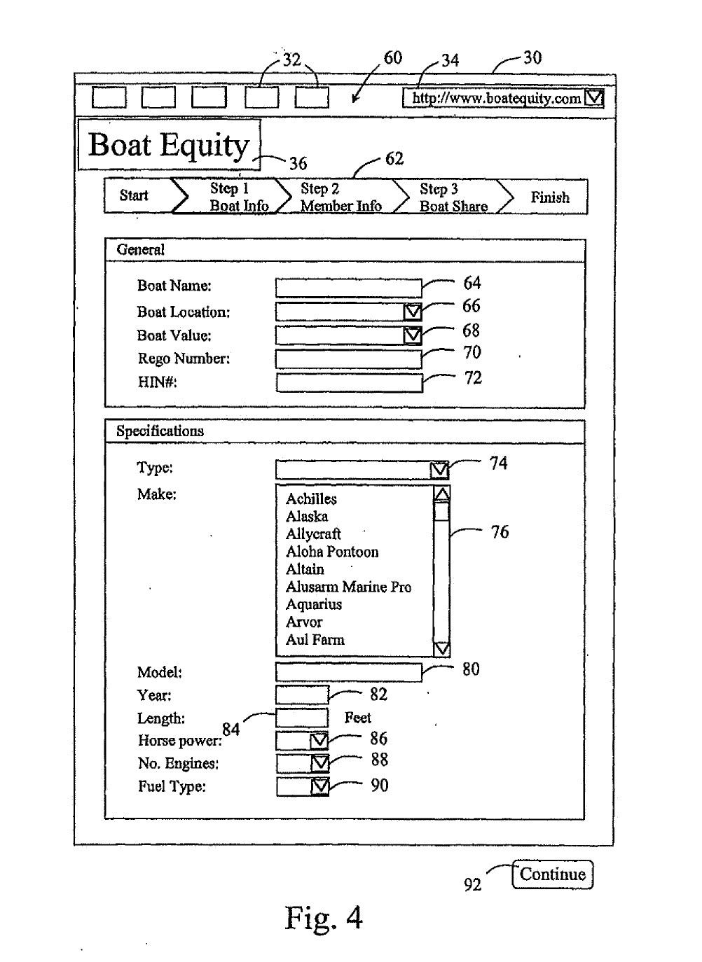

After completion of the signup screen 50, a boat details setup screen 60 as shown in FIG. 4 is displayed.

The boat details setup screen 60 is used to define the type of boat which is to be managed by the system 10.

The boat details setup screen 60 includes a setup progress bar 62 which provides the party with an indication as to the current stage in the signup process.

The boat details setup screen 60 also includes a boat name box 64 which enables a name chosen for the boat by the parties to be recorded on the system, a boat location dropdown box 66 for selecting the state and/or town/city in which the boat is ordinarily located, a boat value dropdown box 68 for selecting a value range appropriate for the boat, and registration and HIN number boxes 70, 72 for entering registration and HIN numbers respectively.

The boat details setup screen 60 also includes a boat type dropdown box 74, a boat make selection box 76, a boat model box 80, a boat year box 82, boat length box 84, an engine horsepower dropdown box 86, an engine number dropdown box 88, and a fuel type dropdown box 90, for entering further specific information particular to the boat to be managed by the system 10.

It will be understood that at least some of the information entered into the system using the boat details setup screen 60 may be used to set default information or to generate default values used in other aspects of the system 10. For example, the location dropdown box 66 may be used to determine the type of calendar to display to a party for use in booking usage of the asset, in particular which days to mark on the calendar as public holidays. As a further example, the boat value dropdown box 68 may be used to determine the monetary value which will be attributed to additional standard points which are purchasable by a party should the party exceed the maximum standard points allocation. As a further example, the engine horsepower dropdown box 86 and the fuel type dropdown box 90 may be used to determine a default value for the fuel rate of the engines, which is used by the system to calculate a monetary amount payable by a party for fuel usage based on the number of engine hours entered into the system by the party.

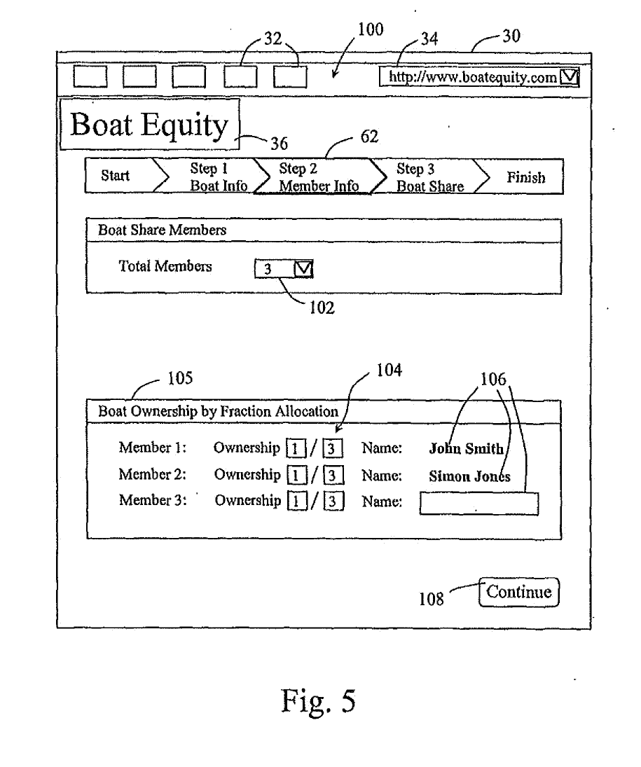

After activating a continue button 92, a members setup screen 100 as shown in FIG. 5 is displayed.

The members setup screen 100 is used to define basic details of the parties involved in the boat to be managed by the system 10. The parties are referred to in the web pages as ‘members’.

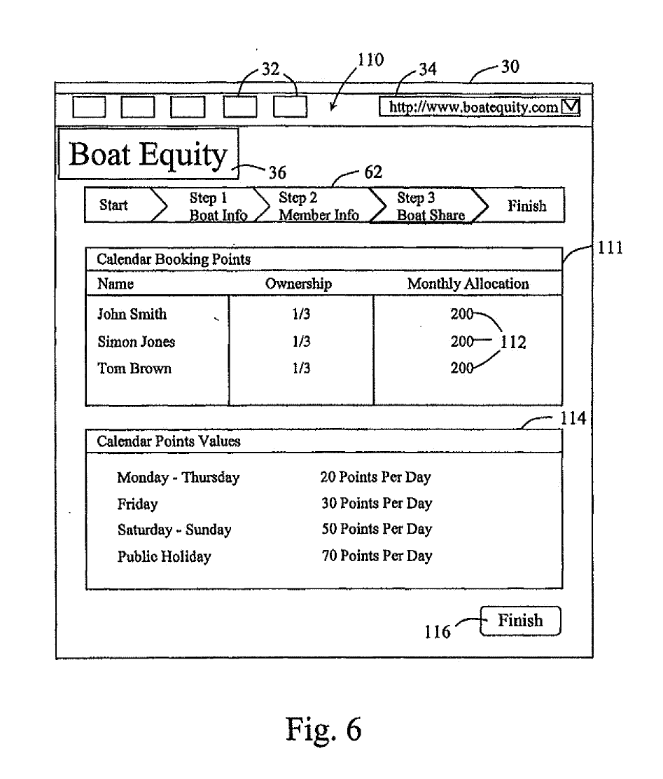

The members setup screen 100 includes a members dropdown box 102 which allows the number of members involved with the boat to be selected, in this example 3. After selection of the number of members, the proportional ownership 104 may be entered into an ownership box 105 by the system 10, and member names are entered by the logged in party into member name boxes 106. In this way, the specific people authorized to use the asset are defined and no other people are able to gain access to the system in order to book usage of the asset. After activating a continue button 108, a points setup screen 110 as shown in FIG. 6 is displayed.

The points setup screen 110 is used to define how many points are allocated to each party per month. In the present arrangement, the system is arranged to allocate a points limit to a party each month based on the proportional ownership and to allow the party to use points in a calendar month such that the number of available points reduces as points are used until the points limit is reached. If a party uses more than the allocated points limit, an additional points fee is payable.

In the present example, a total of 600 standard points are available each month and, accordingly, since three parties exist and each party owns 33% of the asset, 200 standard points are allocated per month to each party.

Although a defined number of monthly booking points are available to each party, a party is able to use more than the allocated monthly points according to defined rules if the party pays for the additional points.

The points setup screen 110 includes a booking points box 111 which lists the parties involved with the asset, and the respective proportional ownership. The booking points box also includes points allocation fields 112 which enable monthly points allocation amounts to be assigned to each of the parties. In the present example, the default number of standard points is 200 for each party.

Also displayed on the points setup screen 110 is a points values box 114 which indicates the number of points associated with particular days, in this example Monday to Thursday, Friday, weekends and public holidays.

It will be understood that higher points are associated with more desirable days in order to encourage fair usage of the asset by all parties.

It will also be understood that for other types of asset, the most desirable booking days may be different, and in such situations the system would be arranged so as to associate higher points values with these different days. For example, in circumstances wherein the asset is a holiday house, the most desirable days may be school holidays, then weekends, then weekdays. The important aspect is that the system is arranged so that the points required for a booking are weighted according to the most desirable days for the asset concerned.

Activating a finish button 116 completes the setup process.

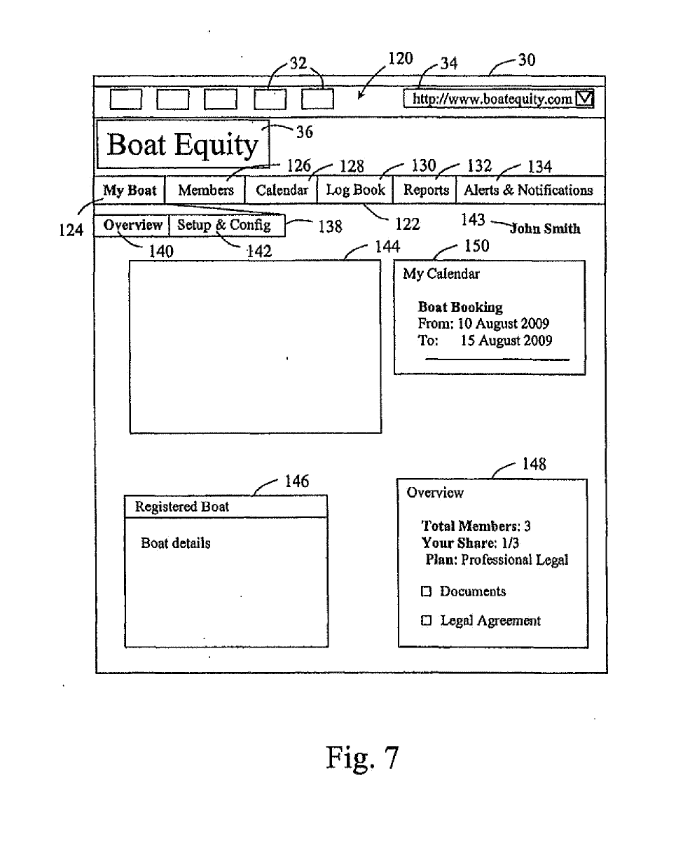

After completion of the setup process by a party or after successful login by the party, a summary screen 120 particular to the logged in party and determined by the login details of the party is displayed, as shown in FIG. 7.

The summary screen 120 includes a menu bar 122 having a series of links which may be used to navigate to different screens in the system. In this example, the menu bar 122 includes a my boat link 124, a members link 126, a calendar link 128, a logbook link 130, a reports link 132 and an alerts and notifications link 134.

Activation of the my boat link 124 causes the summary screen 120 to be displayed and also a sub-menu 138 including an overview sub-link 140 and a setup sub-link 142 to appear below the my boat link 124.

The summary screen 120 displays the name of the logged in party 143 and includes a picture box 144 which may be used to add and display a picture of the boat, a boat details box 146 which includes some boat details entered into the system using the boat details setup screen 60 shown in FIG. 4, an overview box 148 which includes basic membership details including the total number of parties, the membership type that has been selected by the parties, and the proportional share of the logged in party.

In this example, two membership types are available—standard and professional legal.

With a standard membership type, the parties are provided with access to, for example by downloading, a rules document which defines the terms of use, points system, maintenance scheduling, and log book usage for the system 10, and an example budget document which provides a template for creation of an annual budget for maintenance and other recurring expense items.

With a professional legal membership type, the parties are provided with access to, for example by downloading, a rules document, an example budget document, an example meeting procedures document which provides a template for holding a formal meeting, an example meeting minutes document which provides a template for recording meeting minutes in a formal manner, an example proxy form which provides a template for appointing a proxy, and a legal syndicate agreement suitable for defining the framework according to which the parties to the asset are to operate, including each party's obligations and rights during the term of the syndicate, how to deal with disputes, and which includes a share register.

In the present example, the legal agreement includes fields which are automatically populated by the system using information entered into the system by one or more of the parties, in particular information entered at the boat details setup screen 60, the members setup screen 100, and the points setup screen 110.

In this way, parties to the syndicate agreement are automatically provided with a legal agreement suitable for the syndicate entered into by the parties.

The type of membership may be selected using the overview box 148.

The summary screen 120 also includes a bookings box 150 which indicates upcoming boat bookings made by the logged in party.

Activation of the overview sub-link 140 causes the summary screen 120 to be displayed. Activation of the setup sub-link 142 causes a setup screen (not shown) to be displayed which enables the party to modify details entered into the system 10 during the setup process, such as boat details entered using the boat details setup screen 60 shown in FIG. 4.

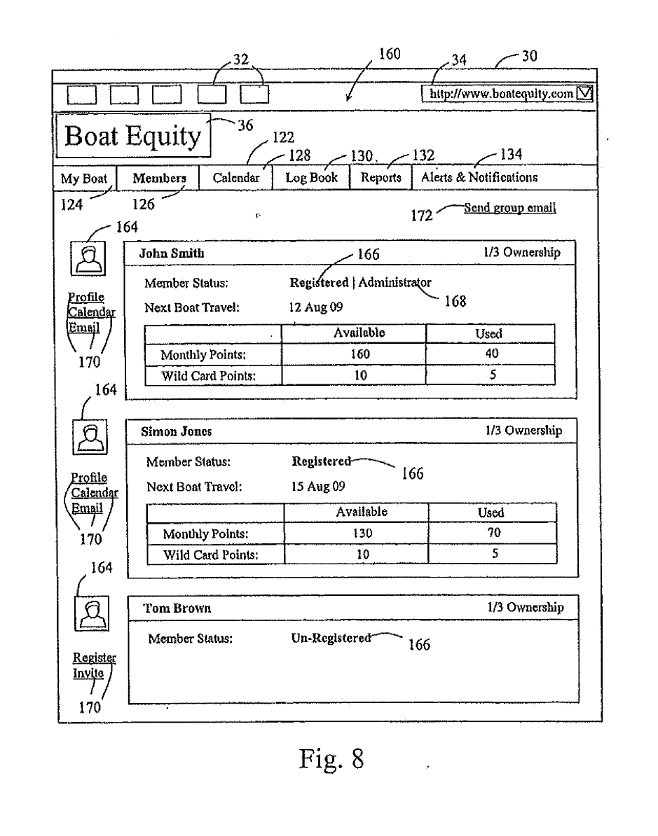

Activation of the members link 126 causes a members screen 160 as shown in FIG. 8 to be displayed, the members screen 160 showing details of all of the parties associated with the managed boat.

For each party, a member icon 164 is provided and in this example the members icons 164 are distinguishable from each other for example by displaying the members icons in different colours.

Each member box 162 includes information as to the registration status 166 of the party and details 168 of any additional responsibility of the party.

In the present example, the system 10 is arranged so as to provide different login types, each login type having a different level of access to information and/or screens in the system. This may be useful for syndicate arrangements wherein syndicate responsibilities are allocated to different parties to the syndicate.

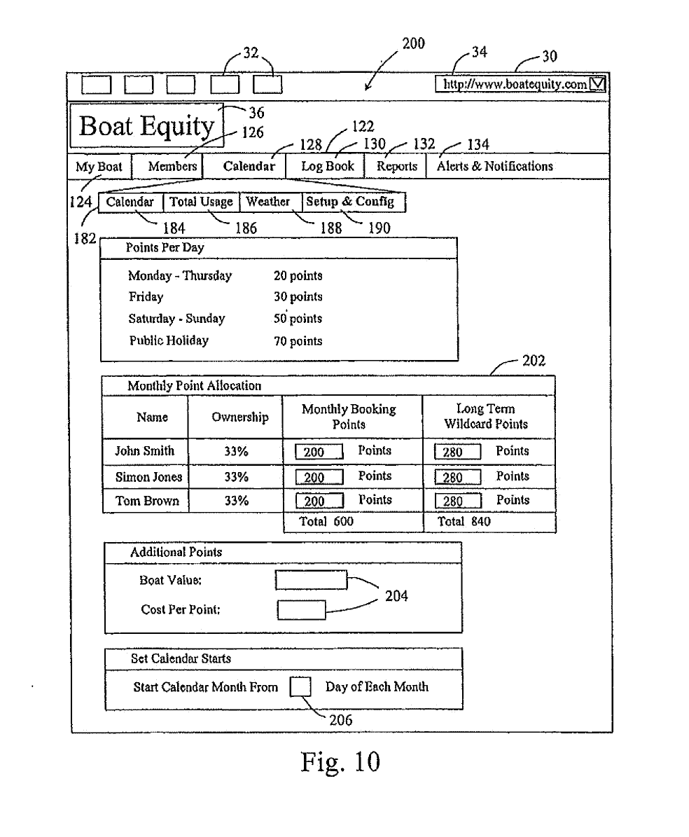

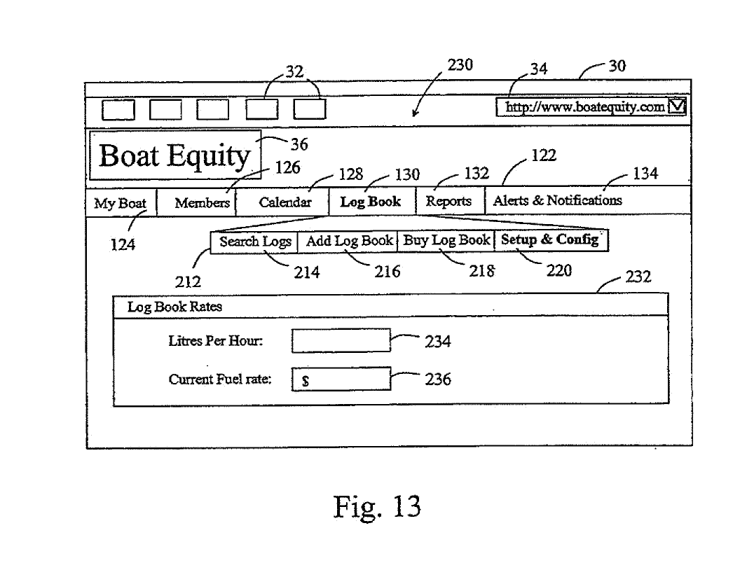

For example, in the present embodiment setup screens 200, 230 shown in FIGS. 10 and 13 may be accessible only by a party provided with administrator responsibilities, and accordingly setup sub-links 142, 190, 220 are only visible to a logged in administrator party.

Allocated responsibilities may include administrator responsibilities, accounts responsibilities, and maintenance responsibilities.

In the present embodiment, three roles are allocatable to the parties as follows:

Maintenance Party

The responsibilities of the maintenance party include to:
arrange annual maintenance, repairs and upgrade work on the boat;
employ contractors to undertake work on the boat;
ensure the relevant insurance company is advised of any major maintenance or work that may affect the cover provided on the boat;
agree with the other parties the general policy to be adopted for maintenance, repair and renewal of equipment on the boat;
co-ordinate regular cleaning of the boat between bookings and use of the boat.

Accounts Party

The responsibilities of the accounts party include to:
manage syndicate accounts and pay accounts to contractors and suppliers;
invoice fuel used by each party from system reports;
calculate contributions required by parties from system reports and issue requests for payment to parties;
project operating costs of the boat with an annual budget for all parties;
present a copy to the syndicate of the actual operating costs incurred together with receipts at the end of each financial year;
open and manage all aspects of the syndicate bank account including signatories of the parties.

Administration Party

The responsibilities of the Administration party include to:
arrange insurance cover for the boat and ensure it is always current;
ensure the boat, pen or mooring is legally registered (including tender if necessary);
keep up to date records of current ownership of the boat through both licensing or registration with the relevant statutory bodies as well as maintaining a Vessel Ownership Register;
arrange for transfer of ownership in the boat in the event a party sells his interest in accordance with the terms of a legal agreement between the parties;
ensure that the Syndicate is operating according to the legal agreement;
hold copies of each party's relevant Skippers Ticket, marine licence or equivalent and register the boat with the local Sea Rescue service;
manage the booking arrangement implemented by the asset management system 10 according to the legal to agreement;
administer default or termination notices pursuant to the legal agreement.

The members screen 160 also includes links 170 which may be used to display a full profile of a party, to send an e-mail to one or more parties, to change the registration status from unregistered to registered, or to invite a party to register with the system 10 and thereby create login and password details for the party.

The members screen 160 also includes a group email link 172 usable to send an email to all parties to the asset managed by the system 10.

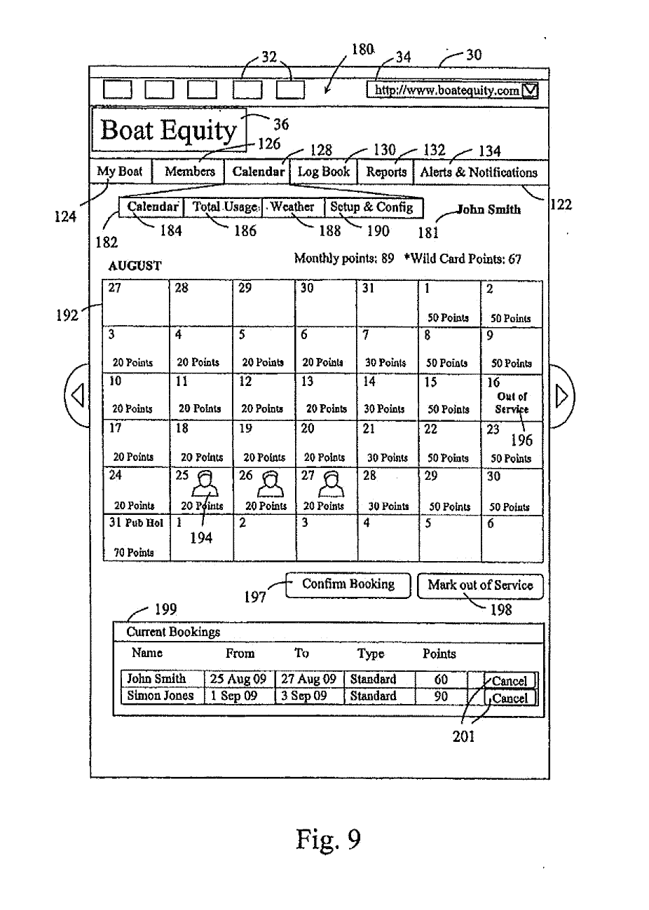

Activation of the calendar link 128 causes a calendar screen 180 as shown in FIG. 9 to be displayed in the web browser 30. The calendar screen 180 is used by a logged in party to review and book usage days by selecting desired days, for example using a mouse.

When the calendar screen 180 is displayed, a calendar sub-menu 182 is also shown, the sub-menu 182 including a calendar sub-link 184, a total usage sub-link 186, a weather sub-link 188 and a setup sub-link 190. Activation of the calendar link 128 or the calendar sub-link 184 causes the calendar screen 180 to be displayed.

The calendar screen 180 displays the name 181 of the logged in party and includes a calendar 192, in this example arranged to display one month and showing on each day of the displayed month the number of points applicable for the day. An icon 194 associated with a party is also shown when the party has booked the day, and an out of service marker 196 is shown when the boat is scheduled for maintenance.

In order for a party to book the boat, the party clicks on the desired day(s), for example using a mouse, and activates a confirm booking button 197. An icon 194 associated with the party then appears on the days selected by the party.

The system is arranged such that when a mouse cursor is disposed over an icon 194 representing a booked day, the date that the booking was made is displayed so as to provide an indication to the booked in party as to when the booking was made and accordingly whether the booking can be challenged.

In the present embodiment, each party is allocated a standard points limit each month and the arrangement is such that the party may use points up to the points limit by making bookings to use the boat.

The system may be arranged such that a defined number of points are allocated for boat usage over a defined period, and the defined number of points apportioned to parties based on the proportional ownership of the parties. In the present example, 600 points are defined for boat usage each month and, accordingly, in the present example, 200 standard points allocated to each party for boat usage each month.

In the present example, the system is arranged such that bookings using standard monthly points can be made no more than two months in advance with the system determining a two month booking window at the start of each month. For example on 1 Aug. 2009 a two month booking window covering August and September is defined, and on 1 Sep. 2009 a new two month booking window covering September and October is defined. In this way, parties are prevented from booking well in advance of usage.

In order to provide flexibility, in the present embodiment each party is also allocated a predetermined number of wildcard points which may be used at any time so that parties are able to make a limited number of advance bookings beyond the normal two month booking window.

In the present example, 840 wild card points are defined for boat usage over a 12 month period and the total available wild card points are apportioned to the parties based on the proportional ownership. Accordingly, in the present example, 280 wild card points allocated to each party per year.

The calendar screen 180 also shows a current bookings box 199 which indicates upcoming bookings for the parties associated with the boat. The current bookings box 199 also includes cancel buttons 201 usable by the administration party to cancel a booking, for example in circumstances wherein the booking was made in error, or where all parties have agreed that the booking party should be able to cancel a booking.

Activation of a setup sub-link 190 causes a calendar setup screen 200 to be displayed as shown in FIG. 10. In this example, the calendar setup screen 200 is accessible only by the administration party. The calendar setup screen 200 includes information as to the points value allocated to each day and includes a points allocation box 202 which enables the administration party to modify the number of available monthly booking points and available wildcard points for each party. It will be understood that the default total monthly number of standard points in the present example is 600 and the default total number of wild card points is 840, with the standard points and wild card points being divided between the parties according to proportional ownership. The points allocation box 202 allows these default points values to be overridden by the administration party.

The calendar setup screen 200 also includes additional points boxes 204 which enable the administration party to assign a monetary value to each point, for example dependent on the value of the boat. In this way, although a defined number of monthly booking points are available to each party, according to defined rules a party is able to use more than the allocated monthly points if the party pays for the additional points. It will be understood that the default monetary value for additional points is automatically determined according to the boat value entered into the boat details setup screen 60, and the additional points boxes 204 allows the default monetary value to be overridden by the administration party.

The system may be arranged to send a communication, such as an email, to the administration party when a party has requested additional points, and the administration party has the option of approving or denying the request.

In the present embodiment, if within 7 days two or more parties request to book to use the boat on the same day, the system will give priority to a party according to the following rules:
on a public holiday, the party who has not booked the boat on the same day in the previous year shall have priority to use the boat. Should both parties be entitled to use the boat according to this criterion, then the party having the lowest number of accumulated points at the time of the dispute will be given priority to use the boat;
on a weekday or weekend, a party having the lowest number of accumulated points will be given priority to use the boat.

Other rules governing points accrual and usage may also be incorporated into the system 10. For example, in the present embodiment, the system is arranged such that unused points are forfeited at the end of each month; the system is arranged so as to define a maximum number of consecutive days which may be booked by a party; and the system is arranged so as to not allow a booking to be cancelled other than by the administration party with consent of all parties.

The calendar setup screen 200 also includes a start calendar month box 206 which defines the day of each month which is used to define the two month booking window described above.

In this example, the boat is provided with a paper log book which is intended to remain on the boat at all times. The log book includes duplicate pages, with a top page of each duplicate pair including a frangible line to enable the copy to be easily removed, and each pair being arranged such that writing on the top page is copied to a bottom page. The bottom page of each pair remains in the log book as a permanent copy. The log book is used to record the name of the booking party, the date, the origin and destination of the journey, and either the engine hours or fuel meter readings for the booking.

During use, when a party books the boat, the party completes a page in the paper log book, removes a top copy, and subsequently uses the information recorded on the removed top copy to enter the required information into the system 10 so that a cost amount can be calculated.

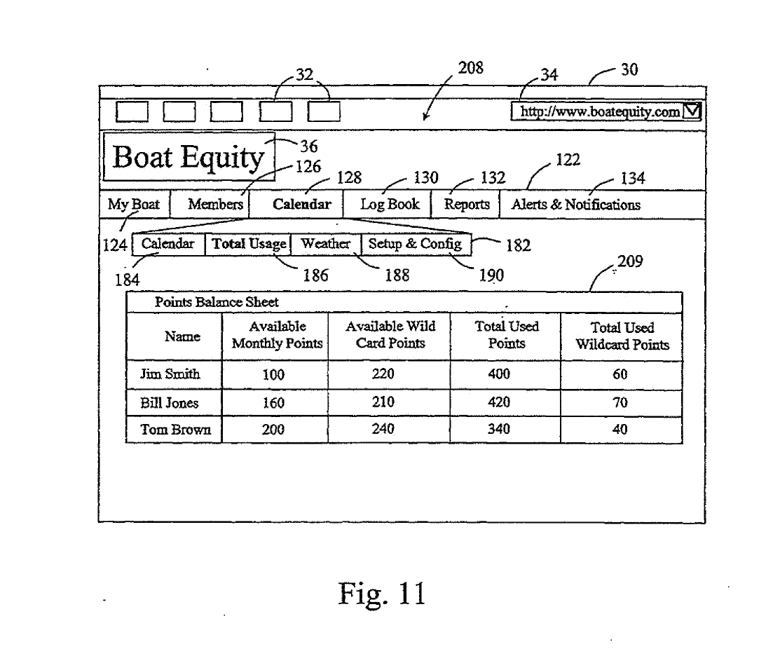

Activation of the total usage sub-link 186 causes a total usage screen 208 as shown in FIG. 11 to be displayed.

The total usage screen 208 includes a points balance box 209 which provides information to the logged in party as to the total points usage for each of the parties to the asset, including the number of available standard points for the current month, the total number of used points, and the total number of used and available wild card points.

Activation of the weather sub-link 188 directs the logged in party to a screen (not shown) which displays relevant weather information particular to the location of the boat, for example derived from the location information entered into the system using the boat details setup screen 60.

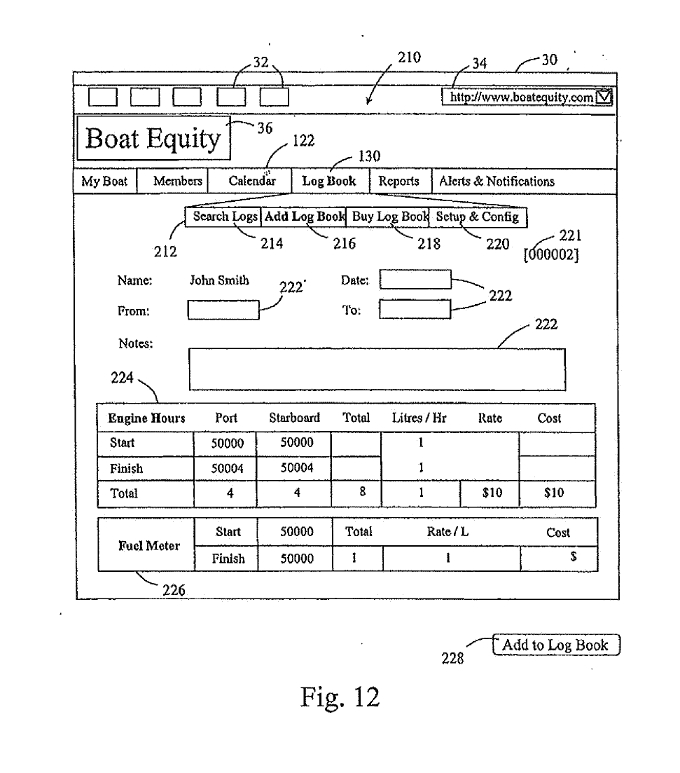

Activation of the logbook link 130 causes a logbook screen 210 as shown in FIG. 12 to be displayed and a logbook sub-menu 212 to appear underneath the logbook link 130. The logbook sub-menu includes a search sub-link 214, an add logbook sub-link 216, a buy logbook sub-link 218 and a setup sub-link 220.

The logbook screen 210 includes a log book number field 221, journey details boxes 222 which enables a party to enter details of the journey including the date of the journey, from and to locations of the journey and any notes relevant to the journey. The logbook screen 210 also includes an engine hours box 224 and a fuel meter box 226. Using either the engine hours box 224 or the fuel meter box 226, a party is able to enter information indicative of the amount of fuel used during a booking and thereby a monetary amount which is owed by the booking party.

It will be understood that in other embodiments the information entered into the logbook may be different. For example, in an embodiment wherein the asset is a holiday house, the log book may record information such as the days spent in the house, electricity and gas used, and so on.

After activation of an add logbook button 228, a logbook record is stored in the database. The log book records are searchable by activating the search logs sub-link 214.

It will be understood that since each log book page removed from the paper log book is assigned a log book number, and the log book number is subsequently entered into the logbook screen 210, it is readily evident to a party when a log book record has not been entered into the system 10 because a log book number is missing.

It will be understood that an estimate of the cost of the fuel used during a booking may be calculated by the system based on default values for fuel usage derived from information entered into the system at the boat details setup screen 60, in particular the engine horsepower, number of engines and fuel type, and based on the number of engine hours used.

It will be appreciated that any other suitable information logging system may be used to record asset usage data instead of a paper based log book having duplicate log book pages. For example, a paper or electronic based logging system may be used at the asset and each party provided with an electronic device such as a PDA, smartphone, or computing device capable of receiving and recording asset usage data such as a laptop iPod® or iPad®. The asset usage data stored on the electronic device may be subsequently transferred to the system 10, for example using a USB connection or using wireless communications.

Activation of the setup sub-link 220 causes a logbook setup screen 230 as shown in FIG. 13 to be displayed, the logbook setup screen 230 including a rates box 232 having a fuel volume per hour field 234 and a current fuel rate field 236 usable to enter the fuel volume per hour used by the engines of the boat (such as litres or gallons per hour) and/or the current cost of fuel per unit volume. The fuel volume per hour field 234 is used to override the fuel volume per hour calculated by the system based on information entered into the system at the boat details setup screen 60. The current fuel cost field is used by the system to calculate the monetary cost to a booking party based on the calculated fuel usage value, or to calculate the monetary cost to a booking party based on the fuel meter values entered into the fuel meter box 226 on the logbook screen 210.

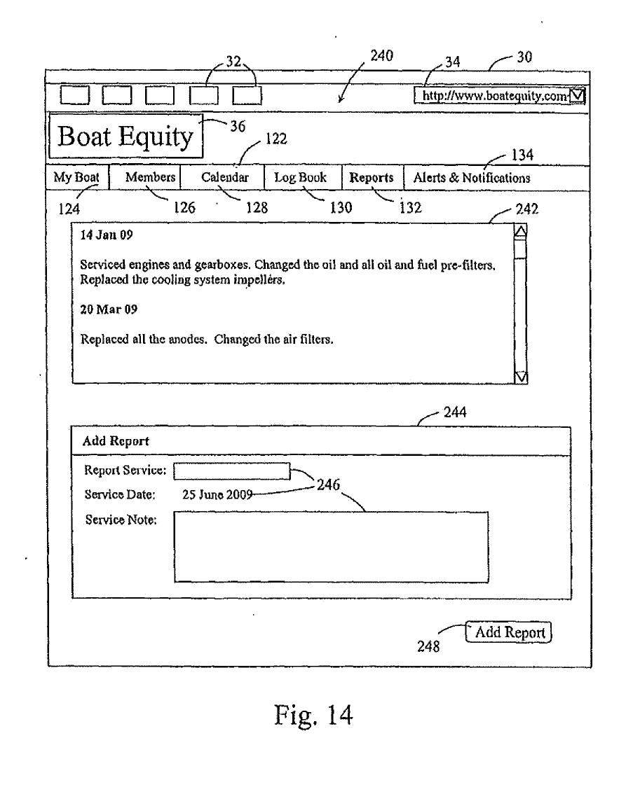

Activation of the reports link 132 causes a report screen 240 to be displayed as shown in FIG. 14.

The reports screen 240 includes a service notes box 242 which displays recently entered service notes, and an add report box 244 including service details fields 246 usable by a party to enter service information into the system. Activation of an add report button 248 causes a report record to be created in the database 18.

The system may be arranged so as to send monthly reports to the parties, for example by email or SMS, such as reports relating to syndicate expenditure, fuel costs incurred by the parties, bookings made, points overbalance and so on.

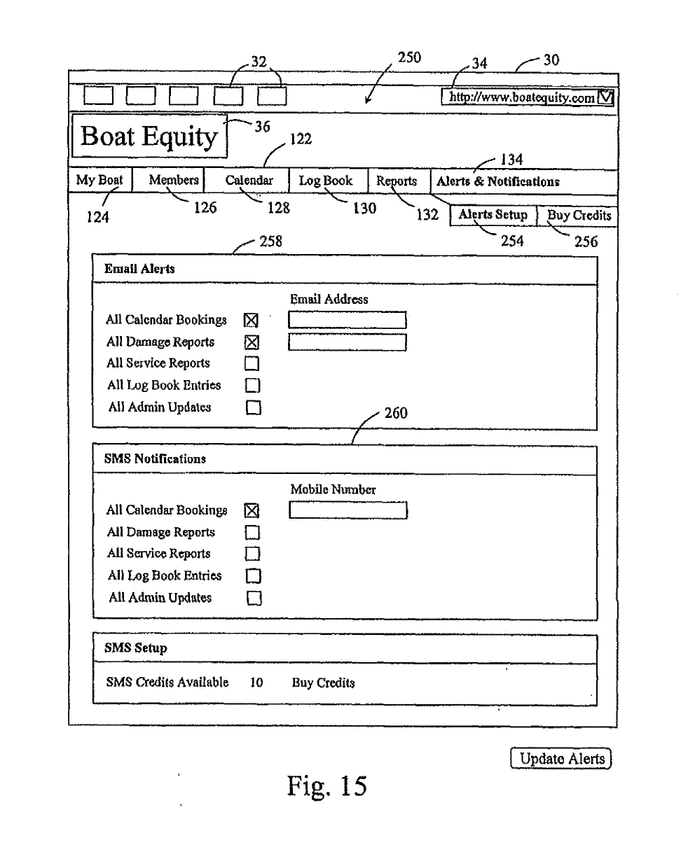

Activation of an alerts link 134 causes an alert screen 250 as shown in FIG. 15 to be displayed and an alerts sub-menu to appear below the alerts link 134.

The alerts screen 250 includes an e-mail alerts box 258 and an sms alerts box 260 which are used by a party to define e-mail and sms types which are desired to be received from the system. For example, a party may desire to receive an e-mail when any of the other parties make a calendar booking, or when a report is entered using the report screen 240.

It will be understood that by receiving an email or SMS indicating that another party has entered a booking into the system, the party is made aware of the prospective booking and may challenge the booking based on predefined rules as described above.

In the present example, a syndicate account is set up for use in receiving monetary amounts associated with the boat from the parties, for example amounts associated with additional points purchased by a party, amounts associated with fuel used by a party, amounts associated with boat servicing and maintenance, and so on. Such monetary receipts may be managed by a party, such as an accounts party.

Modifications and variations as would be apparent to a skilled addressee are deemed to be within the scope of the present invention.

1. A system for managing an asset having a plurality of defined parties authorized to use the asset, the system comprising:
a communications interface arranged to facilitate network communications with the system from a remote location; and
a data storage device arranged to store information indicative of bookings to use the asset by an authorized party to the asset;
the system being arranged to record information indicative of the identity of the parties authorized to use the asset and to allow access to the information indicative of bookings to use the asset by the authorized parties;
the system being arranged to receive a booking request from an authorized party to the asset from a remote location and to store information indicative of received bookings in the data storage device; and
the system being arranged to regulate bookings to use the asset such that usage of the asset by each of the authorized parties is controlled.

2. A system as claimed in claim 1, wherein the system is arranged to regulate bookings by weighting days according to desirability.

3. A system as claimed in claim 1, wherein the system is arranged to allocate points to each day according to desirability whereby relatively more desirable days are allocated a relatively high number of points and relatively less desirable days are allocated a relatively low number of points.

4. A system as claimed in claim 3, wherein weekends are allocated a higher number of points than weekdays.

5. A system as claimed in claim 3, wherein public holidays are allocated the highest number of points, Saturdays and Sundays are allocated the next highest number of points, Fridays are allocated the next highest number of points, and weekdays are allocated the least number of points.

6. A system as claimed in claim 1, wherein the system is arranged to allocate a defined number of standard points usable to book to use the asset to each of the authorized parties.

7. A system as claimed in claim 6, wherein each party is allocated a standard points value each month.

8. A system as claimed in claim 6, wherein the system is arranged so as to add standard points to an accrued standard points amount each time the party books to use the asset up to the standard points value.

9. A system as claimed in claim 6, wherein the system is arranged so as to deduct standard points from the standard points value each time the party books to use the asset.

10. A system as claimed in claim 6, wherein the system is arranged to permit an authorized party to book to use the asset using standard points up to a defined period in advance.

11. A system as claimed in claim 6, wherein the standard points value allocated to each authorized party is determined according to the proportional ownership of the asset by the authorized party.

12. A system as claimed in claim 6, wherein the system is arranged to provide each authorized party with a defined number of wild card points usable to book the asset beyond the defined period.

13. A system as claimed in claim 12, wherein the number of wild card points provided to each authorized party is determined according to the proportional ownership of the asset by the authorized party.

14. A system as claimed in claim 6, wherein the system is arranged to allow an authorized party to purchase standard points beyond the maximum standard points value, the additional points having a defined monetary value.

15. A system as claimed in claim 1, wherein the system is arranged to enable an authorized party to challenge a booking made by another party according to defined rules.

16. A system as claimed in claim 15, wherein the rules are such that, during a challenge, if a booking relates to a public holiday priority for the booking is given to an authorized party who has not booked the boat on the corresponding public holiday in the previous year.

17. A system as claimed in claim 15 wherein the rules are such that during a challenge priority for a booking is given to an authorized party having the lowest total number of used standard points at the time of the challenge.

18. A system as claimed in claim 1, wherein the asset is a boat, a house, a caravan, or an aircraft.

19. A method of managing an asset having a plurality of defined parties authorized to use the asset, the method comprising:
facilitating network communications with the system from a remote location;
recording information indicative of the identity of the parties authorized to use the asset;
allowing access to the information indicative of bookings to use the asset by the authorized parties;
receiving a booking request from an authorized party to the asset from a remote location;
storing information indicative of received bookings in a data storage device; and
regulating bookings to use the asset such that usage of the asset by each defined authorized party is controlled.

20. A method as claimed in claim 19, comprising regulating bookings by weighting days according to desirability.

21. A method as claimed in claim 19, comprising allocating points to each day according to desirability whereby relatively more desirable days are allocated a relatively high number of points and relatively less desirable days are allocated a relatively low number of points.

22. A method as claimed in claim 21, wherein weekends are allocated a higher number of points than weekdays.

23. A method as claimed in claim 21, wherein public holidays are allocated the highest number of points, Saturdays and Sundays are allocated the next highest number of points, Fridays are allocated the next highest number of points, and weekdays are allocated the least number of points.

24. A method as claimed in claim 19, comprising allocating a defined number of standard points usable to book to use the asset to each of the defined authorized parties to the asset.

25. A method as claimed in claim 24, comprising allocating a standard points value to each authorized party each month.

26. A method as claimed in claim 24, comprising adding standard points to an accrued standard points amount each time the authorized party books to use the asset up to the standard points value.

27. A method as claimed in claim 24, comprising deducting standard points from the standard points value each time the party books to use the asset.

28. A method as claimed in claim 24, wherein the method is arranged to permit an authorized party to the asset to book to use the asset using standard points up to a defined period in advance.

29. A method as claimed in claim 24, comprising determining the standard points value allocated to each authorized party according to the proportional ownership of the asset by the authorized party.

30. A method as claimed in claim 24, comprising providing each party to the asset with a defined number of wild card points usable to book the asset beyond the defined period.

31. A method as claimed in claim 30, comprising determining the number of wild card points provided to each authorized party according to the proportional ownership of the asset by the authorized party.

32. A method as claimed in claim 24, comprising allowing an authorized party to purchase standard points beyond the maximum standard points value, the additional points having a defined monetary value.

33. A method as claimed in claim 19, comprising enabling an authorized party to challenge a booking made by another party according to defined rules.

34. A method as claimed in claim 33, wherein the rules are such that, during a challenge, if a booking relates to a public holiday priority for the booking is given to an authorized party who has not booked the boat on the corresponding public holiday in the previous year.

35. A method as claimed in claim 33, wherein the rules are such that during a challenge priority for a booking is given to an authorized party having the lowest total number of used standard points at the time of the challenge.

36. A method as claimed in claim 19, wherein the asset is a boat, a house, a caravan, or an aircraft.

37. A log book for recording data associated with usage of an asset of the type having a plurality of associated parties authorized to use the asset, the log book comprising;
a plurality of primary pages, each primary page including at least one field usable to record data associated with usage of an asset, and each primary page being separable from the log book;
a plurality of secondary pages, each secondary page being associated with a primary page and being a duplicate of the associated primary page and being arranged such that data recorded on the primary page is copied to the associated secondary page.

38. A log book as claimed in claim 37, wherein the asset is a boat, a vehicle or an aircraft, the log book includes fields usable to record the name of a booking party, the date, the origin and destination of a journey, and either the engine hours or fuel meter readings for the journey.

39. A log book as claimed in claim 37, wherein the asset is a house, the log book includes fields usable to record information indicative of days spent in the house, electricity used and/or gas used.
